(19) United States
(12) Patent Application Publication
(10) Pub. No.: US 2022/0094788 A1
(43) Pub. Date: Mar. 24, 2022

(54) SYSTEMS AND METHODS FOR ROUTING A CALL WITH LOCAL TELECOMMUNICATION PLATFORMS

(71) Applicant: Capital One Services, LLC, McLean, VA (US)

(72) Inventors: Tony TANG, Richmond Hill (CA); David BEILIS, Vaughan (CA); Adam PATT, Toronto (CA)

(73) Assignee: Capital One Services, LLC, McLean, VA (US)

(21) Appl. No.: 17/028,783

(22) Filed: Sep. 22, 2020

(51) Int. Cl. H04M 3/51; H04M 3/523; H04M 3/42; H04Q 3/00

(52) U.S. Cl. CPC H04M 3/5183; H04Q 3/005; H04M 3/42059; H04M 3/5232

(57) ABSTRACT

A computer-implemented method that includes determining a call is received from a user device at a first telecommunication provider and determining a first location of the user device based on data transmitted to the first telecommunication provider via the call. The method includes determining a distance between the first location and a location of each of a plurality of telecommunication platforms. Each of the plurality of telecommunication platforms includes a plurality of predefined addresses. The method includes determining a local telecommunication platform of the plurality of telecommunication platforms is positioned closer to the first location than a remainder of the plurality of telecommunication platforms based on the distance of the plurality of telecommunication platforms from the first location. The method includes routing the call from the first telecommunication provider with at least one of the plurality of predefined addresses of the local telecommunication platform.

### TECHNICAL FIELD

Various embodiments of the present disclosure relate generally to a system for routing calls, and relate particularly to methods and systems for determining a local telecommunication platform to route a call between telecommunication providers in different areas.

### BACKGROUND

Forwarding phone calls over a telephone network and between telecommunication providers may result in varying performance, such as, for example, a minimum duration during which the call is being forwarded. A geographic location of an originating source of the phone call (e.g., from a user device) relative to a corresponding location of the telecommunication providers may generally influence performance of the call forwarding process. Further, a distance between the telecommunication providers may be indicative of the minimum duration during which the call is forwarded. Accordingly, telecommunication providers that may be located in different geographic areas (e.g., countries) may cause prolonged wait times for users seeking to connect with a telecommunication provider that is located in a nonlocal area relative to the user.

The present disclosure is directed to addressing one or more of these above-referenced challenges. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY

According to certain aspects of the disclosure methods, systems, and non-transitory computer-readable media are disclosed for routing calls. Each of the examples disclosed herein may include one or more of the features described in connection with any of the other disclosed examples.

In one example, a computer-implemented method for routing calls may include: determining a call is received from a user device at a first telecommunication provider, wherein the user device is positioned at a first location; determining the first location of the user device based on data transmitted to the first telecommunication provider via the call; determining a distance between the first location and a location of each of a plurality of telecommunication platforms, wherein each of the plurality of telecommunication platforms includes a plurality of predefined addresses; determining a local telecommunication platform of the plurality of telecommunication platforms is positioned closer to the first location than a remainder of the plurality of telecommunication platforms based on the distance of the plurality of telecommunication platforms from the first location; and routing the call from the first telecommunication provider with at least one of the plurality of predefined addresses of the local telecommunication platform.

In another example, a computer-implemented method for routing calls may include: detecting transmission of an outgoing call from a user device to a first telecommunication provider; receiving, from a remote server, data indicative of a first location of the user device when the outgoing call is transmitted to the first telecommunication provider; determining a location of a plurality of telecommunication platforms relative to the first location of the user device, wherein each of the plurality of telecommunication platforms includes a plurality of predefined addresses; determining the location of a local telecommunication platform is positioned closer to the first location of the user device than a remainder of the plurality of telecommunication platforms; and transferring the outgoing call from the first telecommunication provider with at least one of the plurality of predefined addresses of the local telecommunication platform.

In a further example, a system may include a processor, and a memory storing instructions that, when executed by the processor, causes the processor to perform operations including: receiving a call from a user device at a first telecommunication provider, wherein the user device is positioned at a first location; determining the first location of the user device based on data transmitted to the first telecommunication provider via the call; determining a distance between the first location and a location of a plurality of telecommunication platforms, wherein each of the plurality of telecommunication platforms include a plurality of predefined addresses; determining a local telecommunication platform of the plurality of telecommunication platforms has a local distance from the first location that is less than the distance of the plurality of telecommunication platforms from the first location; and routing the call from the first telecommunication provider with at least one of the plurality of predefined addresses of the local telecommunication platform.

Additional objects and advantages of the disclosed embodiments will be set forth in part in the description that follows, and in part will be apparent from the description, or may be learned by practice of the disclosed embodiments.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary client-server environment that may be utilized according to aspects of the present disclosure.

FIG. 2 depicts an exemplary process for routing a call between telecommunication providers based on a geolocation of a user device originating the call.

FIG. 3 depicts an example of a computing device, according to aspects of the present disclosure.

### DETAILED DESCRIPTION OF EMBODIMENTS

The terminology used in this disclosure is to be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “computer system” generally encompasses any device or combination of devices, each device having at least one processor that executes instructions from a memory medium. Additionally, a computer system may be included as a part of another computer system.

In this disclosure, the term “based on” means “based at least in part on.” The singular forms “a,” “an,” and “the” include plural referents unless the context dictates otherwise. The term “exemplary” is used in the sense of “example” rather than “ideal.” The term “or” is meant to be inclusive and means either, any, several, or all of the listed items. The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. Relative terms, such as, “substantially,” “approximately,” “about,” and “generally,” are used to indicate a possible variation of ±10% of a stated or understood value.

As used herein, the term “telecommunication provider” may indicate, and may be used interchangeably with, any service provider capable of accepting, transmitting, and delivering a message across a network between two or more points. The service provider may be located in and/or provide telecommunication services over a predefined geographic area, such as, for example, one or more territorial jurisdictions (e.g., a country). By way of illustrative example only, a telecommunication provider may be located in a first country and operable to provide telecommunication services in said first country such that requests to transmit a communication to a second country may require forwarding the communication to another telecommunication provider.

The term “telecommunication platform” may indicate, and may be used interchangeably with, any telephone company and/or operator providing services of wired or wireless telephone and data communications access in various forms, including voice, audio, video, written text, etc. The term “local telecommunication platform” may be indicative of a telephone company and/or operator located in a predefined vicinity of a target object, such as, for example, an originating source of a phone call (e.g., a user device). It should be appreciated that the embodiments of the present disclosure may not be limited to communications across two countries, rather, the systems and methods disclosed herein may be applicable to communications across one or more geographical areas without departing from a scope of this disclosure.

In general, the present disclosure provides methods and systems for routing a call from a first telecommunication provider to a second telecommunication provider using a predefined address based at least in part on a geolocation of a user device from which the call originated from. As will be discussed in greater detail herein, existing techniques may be improved with the methods and systems of the present disclosure.

Users seeking to communicate with a target recipient that is located in a geographical area that is different from that of the user may require forwarding the call from a local telecommunication provider covering the location of the user to a nonlocal telecommunication provider covering the location of the target recipient. Forwarding the call to the nonlocal telecommunication provider may require use of a predefined address, such as, for example, from a Direct Inward Dialing (DID) pool of local phone numbers, that may be derived from a location that varies from the location of the user, thereby increasing a duration required to transmit the call. Accordingly, a need exists to provide a real-time ability to determine a predefined address for routing a call based on a geolocation of the user.

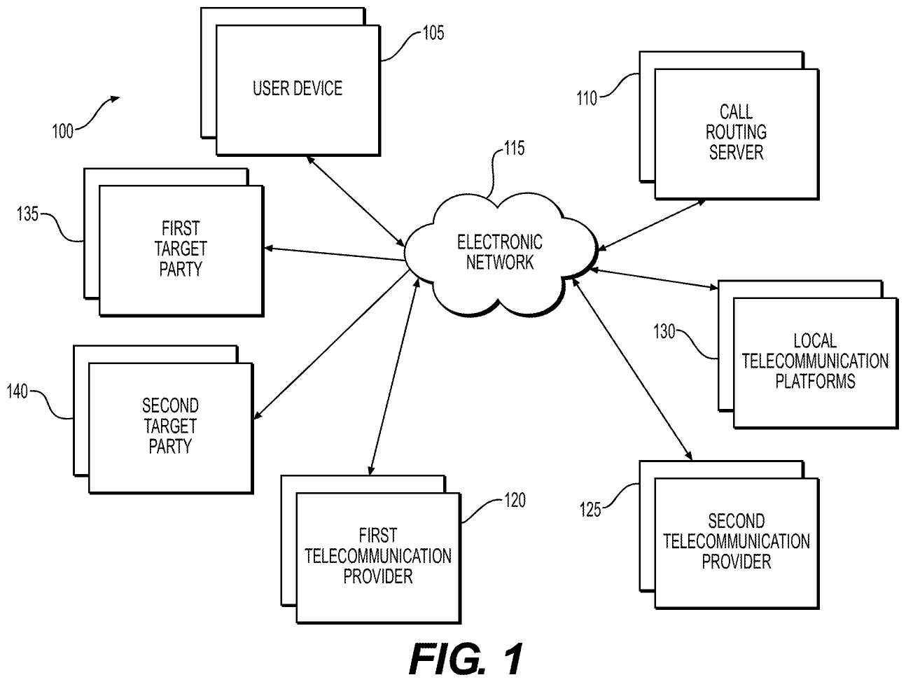

FIG. 1 depicts an exemplary client-server environment that may be utilized with techniques presented herein. For example, the environment may include a system 100 with one or more user devices 105, one or more call routing servers 110, one or more telecommunication providers (such as a first telecommunication provider 120 and a second telecommunication provider 125, collectively referred to as “telecommunication providers 120, 125”), and one or more local telecommunications platforms 130. System 100 may further include one or more call target recipients, including, for example, a first target party 135 and a second target party 140. The one or more components of system 100 may communicate with one another across an electronic network 115 and in any arrangement. It should be appreciated that system 100 may include a plurality of users, each of which may include at least one user device 105. User device 105 may include various suitable apparatuses, including but not limited to, a mobile device, a landline telephone, a computer, and the like. User device 105 may be configured to transmit a call, such as, for example, a telephone communication to one or more target recipients (e.g., first target party 135, second target party 140, and the like). As described in greater detail herein, the call from user device 105 may be transmitted between target parties 135, 140 across the one or more telecommunication providers 120, 125 via network 115.

In the example, system 100 may include at least a first telecommunication provider 120 and a second telecommunication provider 125. Each of the telecommunication providers 120, 125 may be configured to accept, transmit, and deliver a call from user device 105 across a network (e.g., electronic network 115), between two or more points (e.g., first target party 135, second target party 140, and the like). Telecommunication providers 120, 125 may be located in and/or provide telecommunication services over a predefined geographic area, such as, for example, one or more territorial jurisdictions (e.g., a country). Stated differently, telecommunication providers 120, 125 may be configured to provide telecommunications services in one or more geographic locations.

For example, first telecommunication provider 120 may be located in a first geographic area and configured to provide telecommunications services in the first geographic area. As described in detail herein, the first geographic area may be a first country, such as a country from which a call generated by user device 105 may originate. Second telecommunication provider 125 may be located in a second geographic area and configured to provide telecommunications services in the second geographic area. As described in detail herein, the second geographic area may be a second country, such as a country to which the call generated by user device 105 may be directed. In some embodiments, the first geographic area (e.g., the first country) serviced by first telecommunication provider 120 may be different than the second geographic area (e.g., the second country) serviced by second telecommunication provider 125.

Still referring to FIG. 1, the one or more local telecommunications platforms 130 may include a telephone company configured to route telephone and/or data communications across network 115 (e.g., via a wired connection, a wireless connection, etc.). In some embodiments, local telecommunication platforms 130 may be configured to forward a call between one or more target recipients (e.g., first target party 135, second target party 140, and the like) via the one or more telecommunication providers 120, 125. As described in further detail herein, in some embodiments, local telecommunication platform 130 may facilitate routing data (e.g., voice, audio, video, text, etc.) received at first telecommunication provider 120 from user device 105 to second telecommunication provider 125.

In some embodiments, system 100 may include a plurality of local telecommunications platforms 130. Each of the plurality of local telecommunication platforms 130 may be located in a predefined vicinity of a target object, such as, for example, an originating source of a call (e.g., user device 105). Each of the plurality of local telecommunication platforms 130 may include or be associated with one or more (e.g., a plurality) of predefined addresses for routing a call between two points. In some embodiments, the predefined addresses may include a Direct Inward Dialing (DID) pool of local phone numbers that are local to a location of the local telecommunication platform 130. That is, the plurality of predefined addresses of each of the plurality of local telecommunication platforms 130 include a DID grouping of phone numbers that are assigned to a local area of the respective local telecommunication platform 130.

Call routing server 110 may be a remote server configured to determine an optimal route for forwarding a call between telecommunication providers servicing different geographic areas (e.g., first telecommunication provider 120, second telecommunication provider 125, and the like). As described further herein, call routing server 110 may be configured to select at least one of the plurality of local telecommunications platforms 130 to route a call (originating at user device 105) from first telecommunication provider 120 to second telecommunication provider 125 based on a geolocation of user device 105. It should be appreciated that the term “geolocation” and/or “location” may include various forms of detail, data, or information (e.g., latitude and longitude coordinates) relating to a relative location of user device 105.

Still referring to FIG. 1, first target party 135 and second target party 140 may include a target recipient of a phone call from user device 105. In some embodiments, one or more of first target party 135 and second target party 140 may include a call center, an interactive voice response contact system, an individual, and more. In the example, first target party 135 may be located in a first geographic area, such as, for example, the first geographic area (e.g., the first country) serviced by first telecommunication provider 120. Further, second target party 140 may be located in a second geographic area that is different than the first geographic area, such as, for example, the second geographic area (e.g., the second country) serviced by second telecommunication provider 125.

Electronic network 115 may include a telecommunications network such that one or more of user device 105, call routing server 110, first telecommunication provider 120, second telecommunication provider 125, local telecommunication platforms 130, and/or target parties 135, 140 may communicate with one another over the telecommunications network. The telecommunications network may include, for example, a telephone network, a cellular network, and the like. In other embodiments, electronic network 115 may be a public switched telephone network (PTSN), a voiceover Internet Protocol (VoIP) network, a wide area network (“WAN”), a local area network (“LAN”), personal area network (“PAN”), or the like.

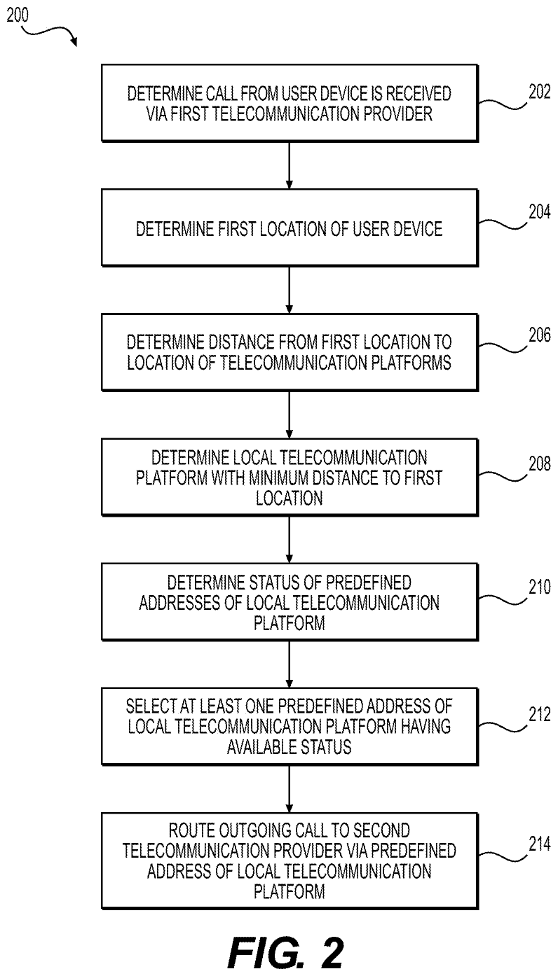

FIG. 2 illustrates an exemplary process 200 for routing a call based on a geolocation of a user (e.g., a calling party) in accordance with embodiments of the present disclosure. It should be understood that the steps described herein, and the sequence in which they are presented, are merely illustrative such that additional and/or fewer steps may be included without departing from the scope of the present disclosure.

Initially, a phone call may originate from user device 105 at a first location, e.g., a calling location. The phone call may be received by network 115 and transmitted to first target party 135 via first telecommunication provider 120. It should be appreciated that the first location of user device 105 may coincide with the first geographic area serviced by first telecommunication provider 120. At step 202, call routing server 110 may be configured to detect and determine that the outgoing phone call transmitted from user device 105 is received at first target party 135 through first telecommunication provider 120.

Still referring to FIG. 2, at step 204, call routing server 110 may be configured to determine the first location of user device 105. Call routing server 110 may determine the first location based on data transmitted to first telecommunication provider 120 and/or first target party 135 via the phone call. In some embodiments, call routing server 110 may be configured to analyze an automatic number identification (ANI) of user device 105, and more particularly a phone number associated with user device 105, to determine the first location. Stated differently, call routing server 110 may be configured to determine the first location by identifying a corresponding portion of the phone number associated with user device 105 that is indicative of a geographic area from which the phone number derives. For example, the corresponding portion of the phone number may refer to an area code, a country code, and the like. In this instance, call routing server 110 may determine a latitude coordinate and a longitude coordinate of user device 105 based on the ANI associated with user device 105.

In other embodiments, call routing server 110 may be configured to determine the first location by retrieving geolocation data from one or more subsystems of user device 105, such as, for example, from a global positioning system (GPS) of user device 105. In this instance, call routing server 110 may determine a latitude coordinate and a longitude coordinate of user device 105 based on the geolocation data retrieved from user device 105. In further embodiments, call routing server 110 may be configured to determine the first location based on one or more user inputs (e.g., from user device). For example, call routing server 110 may analyze data from the one or more user inputs to determine the first location. The one or more user inputs may be received by first target party 135 from user device 105 in response to, for example, one or more prompts from first target party 135 to the user.

Still referring to FIG. 2, with the phone call of user device 105 connected to first target party 135 via first telecommunication provider 120, call routing server 110 may be configured to receive a request to forward the phone call to second target party 140. Second target party 140 may be located in a second geographic area (e.g., country) that is serviced by second telecommunication provider 125 and that is different than the first geographic area of first target party 135 that first telecommunication provider 120 services. Accordingly, it should be appreciated that the request to forward the phone call includes transmitting the call across different telecommunication providers 120, 125 and/or from a first country to a second country.

At step 206, call routing server 110 may be configured to determine a distance between the first location of user device 105 and the plurality of local telecommunications platforms 130. Call routing server 110 may identify the plurality of local telecommunication platforms 130 positioned within a vicinity of user device 105 based on the first location and compute a distance (e.g., a geographic distance of separation) between user device 105 and a location of each of the plurality of local telecommunication platforms 130. As described in detail above, each of the plurality of local telecommunication platforms 130 may include a plurality of predefined addresses for use in transferring a call between at least two points.

At step 208, call routing server 110 may be configured to determine at least one of the plurality of local telecommunication platforms 130 having a distance from the first location that is less than the geographic separation distance of the remaining plurality of local telecommunication platforms 130 to the first location. In other words, call routing server 110 may determine at least one of the local telecommunication platforms 130 that is positioned closer (e.g., has a minimum separation distance) to the first location than the remaining plurality of local telecommunication platforms 130. The at least one local telecommunication platform 130 may serve as a routing location for forwarding the phone call from first target party 135 to second target party 140. In this instance, call routing server 110 may be operable to utilize a predefined address of the at least one local telecommunication platform 130 having a minimum distance from the first location to improve a performance of routing the call from first target party 135 to second target party 140.

Still referring to FIG. 2, at step 210, call routing server 110 may be configured to determine a current status of the plurality of predefined addresses of the at least one local telecommunication platform 130. For example, each of the plurality of predefined addresses may include a status, such as available, unavailable, inactive, active, in use, and the like. Call routing server 110, at step 212, may select at least one of the plurality of predefined addresses having an available and/or inactive status for use in routing the phone call from first target party 135 to second target party 140.

At step 214, call routing server 110 may be configured to route the phone call with first target party 135 from first telecommunication provider 120 to second telecommunication provider 125 to connect with second target party 140. Call routing server 110 may route the phone call with the at least one of the plurality of predefined address (identified at step 212) of the at least one local telecommunication platform 130 (identified at step 208). In the example, second target party 140 may be located in a second geographic area (e.g., country) that is different than first target party 135. By utilizing a local predefined address (e.g., a phone number), provided by the local telecommunication platform 130 positioned in close proximity to the first location of user device 105, a performance of routing the phone call from a first country to a second country may be improved by call routing server 110. For example, call routing server 110 may be configured to reduce a required duration (e.g., wait time) for routing the phone call from first target party 135 with first telecommunication provider 120 to second target party 140 with second telecommunication provider 125. For instance, the required duration may be reduced by about 1 second to about 60 seconds.

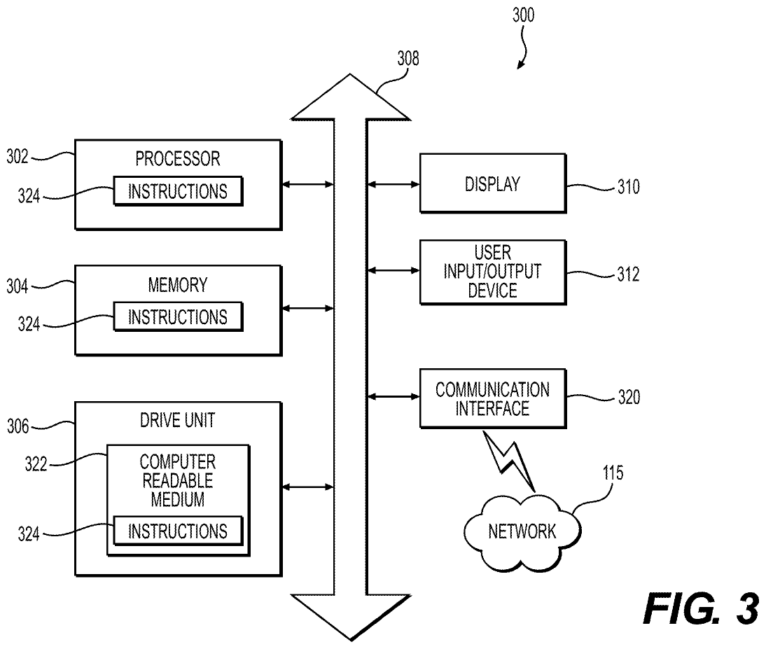

FIG. 3 is a simplified functional block diagram of a computing device 300 that may be configured as a device for executing the methods of FIG. 2, according to exemplary embodiments of the present disclosure. Any of the devices, databases (e.g., servers), processors, etc. of system 100 discussed herein may be an assembly of the hardware of computing device 300 including, for example, user device 105, call routing server 110, first telecommunication provider 120, second telecommunication provider 125, and/or target parties 135, 140, according to exemplary embodiments of the present disclosure.

Computing device 300 may include a central processing unit (“CPU”) 302 that may be in the form of one or more processors configured to execute program instructions, such as those of process 200 described in detail above. In some embodiments, the processor(s) of CPU 302 includes both a CPU and a GPU. Computing device 300 may further include a storage unit 306 that may include non-volatile memory, such as, for example, a storage media (e.g., solid-state drives), ROM, HDD, SDD, etc. Examples of storage media include solid-state storage media (e.g., solid state drives and/or removable flash memory), optical storage media (e.g., optical discs), and/or magnetic storage media (e.g., hard disk drives). Storage unit 306 may store data on a computer readable medium 322. In some embodiments, computing device 300 may receive programming and data via network communications from electronic network 115, such as, for example, via a communication interface 320 configured to communicate with one or more other components of system 100.

Still referring to FIG. 3, computing device 300 may include a memory 304 that is volatile memory, such as, for example, RAM, solid-state memories, optical storage media (e.g., optical discs), magnetic storage media (e.g., hard disk drives), etc. Memory 304 may be configured for storing one or more instructions 324 for executing techniques presented herein, such as those of process 200 shown and described above. Memory 304 may further include a non-transitory computer-readable medium. Therefore, whenever a computer-implemented method is described in this disclosure, this disclosure shall also be understood as describing a non-transitory computer-readable medium storing instructions that, when executed by one or more processors (e.g., CPU 302), cause the one or more processors to perform the computer-implemented method.

In some embodiments, the one or more instructions 324 may be stored temporarily or permanently within other modules of computing device 300, such as, for example, CPU 302, computer readable medium 322, and more. Computing device 300 may include an input/output device 312 including one or more input ports and one or more output ports. Input/output device 312 may include, for example, a keyboard, a mouse, a touchscreen, etc. (i.e., input ports). Input/output device 312 may further include a monitor, a display, a printer, etc. (i.e. output ports). Computing device 300 may further include a display device 310 configured to connect with input/output device 312. The aforementioned elements of computing device 300 may be connected to one another through an internal communication bus 308, which represents one or more busses.

In other embodiments, the various system functions of process 200 shown in FIG. 2 may be implemented in a distributed fashion on a number of similar platforms to distribute the processing load on multiple computing devices 300. Alternatively, the system functions may be implemented by appropriate programming of one computer hardware platform, such as, for example, computing device 300.

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming.

All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

While the presently disclosed methods, devices, and systems are described with exemplary reference to transmitting data, it should be appreciated that the presently disclosed embodiments may be applicable to any environment, such as a desktop or laptop computer. Also, the presently disclosed embodiments may be applicable to any type of Internet protocol. It is intended that the specification and examples be considered as exemplary only, with a true scope and spirit of the disclosure being indicated by the following claims.

In general, any process discussed in this disclosure that is understood to be performable by a computer may be performed by one or more processors. Such processes include, but are not limited to, the process shown in FIG. 2, and the associated language of the specification. The one or more processors may be configured to perform such processes by having access to instructions (computer-readable code) that, when executed by the one or more processors, cause the one or more processors to perform the processes. The one or more processors may be part of a computer system (e.g., one of the computer systems discussed above) that further includes a memory storing the instructions. The instructions also may be stored on a non-transitory computer-readable medium. The non-transitory computer-readable medium may be separate from any processor. Examples of non-transitory computer-readable media include solid-state memories, optical media, and magnetic media.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Steps may be added or deleted to methods described within the scope of the present invention.

The above-disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations and implementations are possible within the scope of the disclosure. Accordingly, the disclosure is not to be restricted except in light of the attached claims and their equivalents.

1. A computer-implemented method for routing calls, comprising:
determining a call to a target party is received from a user device via a first telecommunication provider, wherein the user device is positioned at a first location;
determining the first location of the user device based on data transmitted with the call via the first telecommunication provider;
determining a distance between the first location and a location of each of a plurality of telecommunication platforms, wherein each of the plurality of telecommunication platforms includes a plurality of predefined addresses;
determining a local telecommunication platform of the plurality of telecommunication platforms is positioned closer to the first location than a remainder of the plurality of telecommunication platforms based on the distance of the plurality of telecommunication platforms from the first location; and
routing the call from the first telecommunication provider with at least one of the plurality of predefined addresses of the local telecommunication platform to a second telecommunication provider, the second telecommunication provider being in communication with the target party.

14. A computer-implemented method for routing calls, comprising:
detecting transmission of an outgoing call to a target party from a user device to a first telecommunication provider;
receiving, from a remote server, data indicative of a first location of the user device when the outgoing call is transmitted to the first telecommunication provider;
determining a location of a plurality of telecommunication platforms relative to the first location of the user device, wherein each of the plurality of telecommunication platforms includes a plurality of predefined addresses;
determining the location of a local telecommunication platform is positioned closer to the first location of the user device than a remainder of the plurality of telecommunication platforms; and
transferring the outgoing call from the first telecommunication provider to a second telecommunication provider with at least one of the plurality of predefined addresses of the local telecommunication platform, wherein the second telecommunication provider being in communication with the target party.
